(19) United States
(12) Patent Application Publication
(10) Pub. No.: US 2024/0198609 A1
(43) Pub. Date: Jun. 20, 2024

(54) METHOD AND DEVICE FOR MANUFACTURING COMPOSITE WING COVERS

(71) Applicant: AIRBUS OPERATIONS, S.L.U., Madrid (ES)

(72) Inventors: Diego GARCÍA MARTIN, Madrid (ES); Fernando MUÑOZ AJENJO, Madrid (ES); Georgina GALERA CÓRDOBA, Madrid (ES); Alexander IBISATE GONZALEZ DE MATAUCO, Madrid (ES); Fernando ESQUIVIAS GARCIA, Madrid (ES)

(21) Appl. No.: 18/522,445

(22) Filed: Nov. 29, 2023

(30) Foreign Application Priority Data
Dec. 19, 2022 (EP) 22383235.3

(51) Int. Cl. B29C 70/78; B29C 70/44

(52) U.S. Cl. CPC B29C 70/78; B29C 70/446; B29L 2031/3085

(57) ABSTRACT

A process for manufacturing composite wing covers is provided that includes placing a laminate inside each of a plurality of shaping tools. Shaping the laminates and pressing the laminates against the shaping tools. Retaining the shaped laminates inside the shaping tools and turning over the shaped laminates. Attaching a skin to the shaped laminates and curing the skin and the shaped laminates. Heating the shaping tools and creating a vacuum in the shaping tools.

### CROSS REFERENCE(S) TO RELATED APPLICATION(S)

This application claims priority to European patent application EP 22383235.3, filed Dec. 19, 2022, the entire contents of which are hereby incorporated by reference.

### TECHNICAL OVERVIEW

The technology described herein relates to techniques that include a method and a device for manufacturing composite wing covers, in particular, to a method for manufacturing composite wing covers comprising stringers and a skin.

### INTRODUCTION

Aircrafts use composite wing covers, which comprise stringers and a skin.

The stringers are formed to a desired shaped, such as an omega cross-section shape, and the stringers are co-cored onto the skin, such a prepreg skin, which has been previously laminated. The devices currently known for manufacturing this kind of composite wing covers comprises female tools where laminates are positioned for shaping and forming the stringers.

Once positioned in the female tools, semirigid inflatable mandrels are applied over them onto the inner surface, and then a lay-up operation is performed for positioning the skin on the shaped laminates, i.e., the stringers.

Finally, the stringers and the skin are co-cured using an autoclave.

In practice, it has been seen that the method and device used for manufacturing these composite wing covers is complex and requires an extended time.

Accordingly, it will be appreciated that new and improved techniques, systems, and processes are continually sought after.

### SUMMARY

Certain example embodiments provide a method and a device for manufacturing composite wing covers which can simplify and/or shorten the lead time for preparing the stringers and ready for a co-curing process compared to the state of the art methods and devices. In certain example embodiments, the disadvantages are addressed, presenting other advantages that will be described below.

In certain example embodiments, a method for manufacturing composite wing covers is provided and includes:
placing a laminate inside each of a plurality of shaping tools;
shaping the laminates pressing the laminates against the shaping tools;
retaining the shaped laminates inside the shaping tools;
turning over the shaped laminates;
attaching a skin to the shaped laminates; and
curing the skin and the shaped laminates, heating the shaping tools and creating a vacuum in the shaping tools.

Advantageously, the shaped laminates are retained inside the shaping tools by magnetism.

Furthermore, in the curing step, the vacuum is preferably created in the shaping tools closing a vacuum bag around the shaping tools.

According to a preferred embodiment, the heating of the shaping tools is done by heating longitudinally the internal surface of the shaping tools.

The device for manufacturing composite wing covers comprises:
a plurality of shaping tools for placing a laminate inside each of them;
deforming tools for pressing the laminates against the shaping tools for shaping the laminates;
magnetic means for retaining the shaped laminates inside the shaping tools; and
the shaping tools comprise heating elements for curing the shaped laminates.

Advantageously, the device also comprises a vacuum bag, that is closed around the shaping tools when the shaped laminates are cured.

According to a preferred embodiment, the magnetic means comprises:
a ferromagnetic element of a mandrel that is placed inside each shaping tool, with each shaped laminate being sandwiched between the mandrel and the shaping tool; and
a magnet that is placed in correspondence with each shaping tool.

Preferably, the heating elements are longitudinal heating elements that are embedded in each shaping tool.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

For better understanding of what has been disclosed, some drawings in which, schematically and only by way of a non-limiting example, a practical case of embodiment is shown.

FIG. 1 is an elevation section view of a shaping tool of the device according to certain example embodiments, showing the positioning of a laminate in the shaping tool;

FIG. 2 is an elevation section view of a shaping tool of the device according to certain example embodiments, showing the deformation of the laminate by deforming tools;

FIG. 3 is an elevation section view of a shaping tool of the device according to certain example embodiments, showing the placement of mandrels in the shaping tool once the laminate has been deformed;

FIG. 4 is an elevation section view of a shaping tool of the device according to certain example embodiments, showing the turning over of the shaping tool and placing the stringer on a skin;

FIG. 5 is an elevation section view of a shaping tool of the device according to certain example embodiments, showing the co-curing of the stringer and the skin; and

FIG. 6 is an elevation section view showing the final composite wing cover.

### DETAILED DESCRIPTION

A method according to certain example embodiments is carried out in the device that includes the following steps.

In the drawings it must be pointed out that only the formation of one stringer is shown for simplicity reasons. However, the composite wing cover manufactured by the method and device discussed herein may comprise a plurality of stringers and a skin, so that the machine also comprises a plurality of corresponding elements that will be described hereinafter.

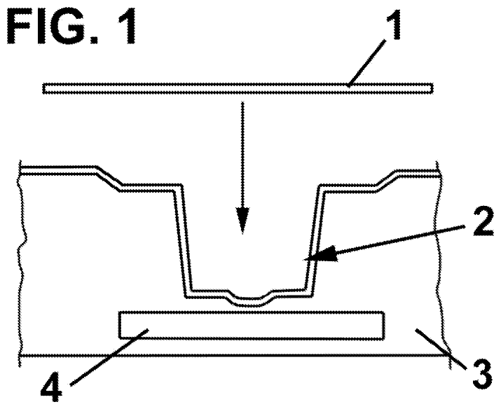

In a first step, shown in FIG. 1, a laminate 1 is placed inside a shaping tool 2 having a cavity with the complementary shape of the string to be obtained, such as an omega shape. This shaping tool 2 is placed on a frame 3 of the device and the frame 3 comprises a magnetic element 4 associated with the shaping tool 2, i.e., placed near the shaping tool 2. The function of the magnetic element 4 will be explained hereinafter.

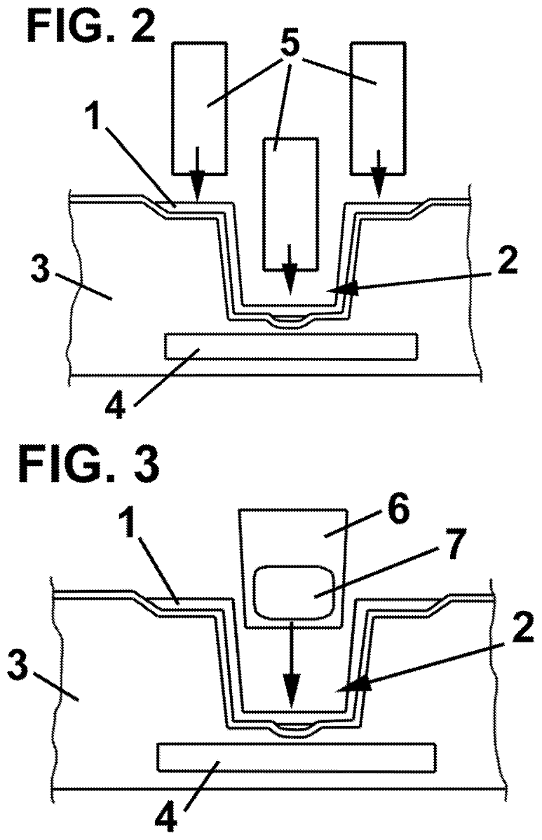

Once placed inside the shaping tool 2, and as shown in FIG. 2, the laminate 1 is shaped by deforming tools 5, which press the laminate 1 against the shaping tool 2, so that the laminate 1 is shaped or deformed to the desired shape, forming the shaped laminate 1 or stringer.

Then, as shown in FIG. 3, a semi-rigid inflatable mandrel 6 is positioned on the hollow formed by the laminate 1 once deformed. The purpose of this semi-rigid inflatable mandrel 6 is to provide inner pressure over the inner surface of the shaped laminate 1 during the curing step, that will be explained later.

Within the semi-rigid inflatable mandrel 6 a ferromagnetic element 7 is included with the objective of providing a magnetic behavior to retain the shaped laminate 1 in place when a turn over is carried out for rotating 180° the shaped laminate 1 by conventional turning means.

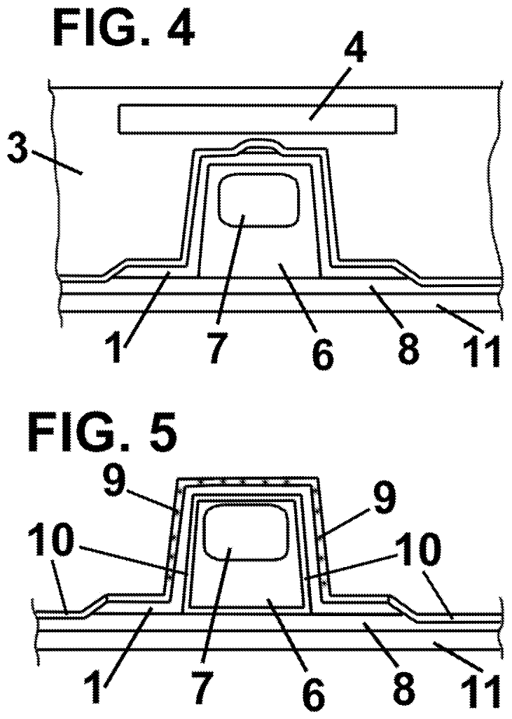

In FIG. 4 the position of the shaping tool 2 and the shaped laminate 1 once rotated 180° is shown. In this position the shaped laminate 1 is attached to a skin 8, such as a prepreg skin previously laminated, and then the frame is released from the shaped laminate 1.

Finally, a curing step is carried out. For this curing step, the shaping tool 2 comprises heating elements 9, such as longitudinal heating elements, e.g., cables, embedded in the shaping tool 2, so that the surface of the shaping tool 2 can be heated during the curing step. This heating elements 9, together with a heating curing tool 11 for the skin, avoid the need of an autoclave for curing the cover, formed by the skin 8 and shaped laminates 1.

Furthermore, the device according to certain examples also comprises a vacuum bag 10 for providing vacuum during the curing step. The vacuum bag 10 is closed around the shaping tool 2, so that the surface to be covered is reduced (e.g., significantly) compared to classical configurations.

This way, only a hyperbaric chamber would be required instead of an autoclave, with ambient temperature instead of a 180° C. temperature for an autoclave. Consequently, the energy consumption can be reduced (e.g., significantly).

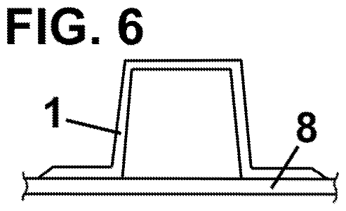

A portion of the final composite wing cover manufactured by the method and device according to certain example embodiments is shown in FIG. 6, comprising a plurality of shaped laminates 1, or stringer, and a skin 8, even though only one stringer is shown in this figure.

It will be appreciated that the number of stringers in the composite wing cover can determine the number of shaping tools 2 in the device according to certain example embodiments.

The manufactured composite wing cover produced via the techniques herein may then form part of a wing that is part of an aircraft. In certain examples, the laminate that is used in forming the composite wing cover may extend over at least a portion (e.g., a substantial portion) of the wing of an aircraft. The composite wing cover may be cured with multiple stringers that are in parallel to one another. These may be used to support the composite wing cover.

While at least one exemplary embodiment of the present invention(s) is disclosed herein, it should be understood that modifications, substitutions, and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The elements described in this document include actions, features, components, items, attributes, and other terms. Whenever it is described in this document that a given element is present in “some embodiments,” “various embodiments,” “certain embodiments,” “certain example embodiments, “some example embodiments,” “an exemplary embodiment,” “an example,” “an instance,” “an example instance,” or whenever any other similar language is used, it should be understood that the given element is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments.

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an”, and “the” should be read as meaning “at least one,” “one or more,” or the like; the term “example”, which may be used interchangeably with the term embodiment, is used to provide examples of the subject matter under discussion, not an exhaustive or limiting list thereof; the terms “comprise” and “include” (and other conjugations and other variations thereof) specify the presence of the associated listed elements but do not preclude the presence or addition of one or more other elements; and if an element is described as “optional,” such description should not be understood to indicate that other elements, not so described, are required.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A method for manufacturing composite wing covers, comprising:
placing a laminate inside each of a plurality of shaping tools;
shaping the laminates by pressing the laminates against the shaping tools;
retaining the shaped laminates inside the shaping tools;
turning over the shaped laminates;
attaching a skin to the shaped laminates; and
curing the skin and the shaped laminates based at least in part by heating the shaping tools and creating a vacuum in the shaping tools.

2. The method of claim 1, wherein the shaped laminates are retained inside the shaping tools by magnetism.

3. The method of claim 1, wherein the vacuum is created in the shaping tools by closing a vacuum bag around the shaping tools.

4. The method of claim 1, wherein the heating of the shaping tools is done by heating longitudinally the internal surface of the shaping tools.

5. A device for manufacturing composite wing covers, the device comprising:
a plurality of shaping tools configured to accept a laminate inside each of them;
deforming tools configured to press the laminates against the shaping tools for shaping the laminates;
a magnetic element configured to retain the shaped laminates inside the shaping tools; and
heating elements configured to cure the shaped laminates, wherein the shaping tools comprise the heating elements.

6. The device of claim 5, further comprising a vacuum bag that is closed around the shaping tools when the shaped laminates are cured.

7. The device of claim 5, wherein the magnetic element comprises:
a ferromagnetic element of a mandrel that is placed inside each shaping tool, with each shaped laminate being sandwiched between the mandrel and the shaping tool; and
a magnet that is placed in correspondence with each shaping tool.

8. The device of claim 5, wherein the heating elements are longitudinal heating elements that are embedded in each shaping tool.

9. A method for manufacturing composite wing covers for an aircraft, the method comprising:
placing a plurality of laminates inside, respectively, each of a plurality of shaping tools;
shaping the plurality of laminates by pressing against each respective one of the plurality of shaping tools;
retaining the plurality of shaped laminates inside the plurality of shaping tools;
while the plurality of shaped laminates are retained inside the plurality of shaping tools:
turning the plurality of shaped laminates, and
attaching a skin to the plurality of shaped laminates; and
performing a curing process for the skin and the plurality of shaped laminates based at least in part by heating the shaping tools.

10. The method of claim 9, wherein the curing process includes creating a vacuum in the plurality of shaping tools.

11. The method of claim 10, wherein the vacuum is created in the plurality of shaping tools by closing a vacuum bag around each one of the plurality of shaping tools.

12. The method of claim 9, wherein the skin is attached to the plurality of shaped laminates after the plurality of shaped laminates have been turned over.

13. The method of claim 9, further comprising:
as part of retaining the plurality of shaped laminates inside the plurality of shaping tools, positioning a mandrel against the plurality of shaped laminates inside the plurality of shaping tools.

14. The method of claim 13, wherein the mandrel includes a ferromagnetic element that, in combination with a magnet, provides a magnetic field that is used to retain the plurality of shaped laminates inside the plurality of shaping tools.

15. The method of claim 14, further comprising:
maintaining the mandrel against the plurality of shaped laminates during the curing process.
